(19) United States
(12) Patent Application Publication
(10) Pub. No.: US 2006/0164821 A1
(43) Pub. Date: Jul. 27, 2006

(54) Illumination device including ultraviolet emitting element, and an electronic apparatus using the same

(75) Inventor: Norihisa Usui, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD

(21) Appl. No.: 10/529,940

(22) PCT Filed: Oct. 9, 2003
(86) PCT No.: PCT/JP03/12989

§ 371 Date: Apr. 1, 2005

(30) Foreign Application Priority Data
Oct. 9, 2002 (JP) 2002-296076

(51) Int. Cl. G01D 11/28; F21V 9/16

(52) U.S. Cl. 362/23; 362/29; 362/84

(57) ABSTRACT

An illumining device illumining a whole indicator brightly, using a light emitting element that emits rays of light in an ultraviolet ray region, and an electronic apparatus using the illumining apparatus. The illumining device comprises a light emitting element (17) disposed within a case (14) for emitting rays of light in an ultraviolet ray region, optically transparent sealing resin (18) with which the case is filled so as to cover the light emitting element, and a luminous material (19, 22) mixed into the sealing resin for reacting to the rays of light in the ultraviolet ray region to thereby emit rays of light in a visible ray region. The rays of light in the ultraviolet ray region emitted by the light emitting element pass through the sealing resin and then exits from the illumining device. Furthermore, they illumines the luminous material mixed into the sealing resin to cause the same to emit rays of light in the visible ray region.

### BACKGROUND OF THE INVENITION

1. Technical Field of the Invention

The present invention relates to useful illumining devices applied to various devices such as wristwatches, cellular phones, and car meters, and electronic apparatus using the illumining devices.

2. Background Art

For example, a wristwatch with a sweep-second hand includes an illumining device housed within its case to illumine an indictor including hour, minute and second hands and/or face to allow a user to know time even in a dark place.

In the past, such wristwatch includes within its case an ultraviolet ray emitting element as an illumining device, and luminous layers provided on the indicator including the hands and/or face, the luminous layers reacting to rays of light in the ultraviolet ray region to thereby emit rays of light in the visible ray region. When invisible rays of light in the ultraviolet ray region emitted by the ultraviolet ray-emitting element illumines the indictor members, the luminous layers on the indicator members react to the rays of light in the ultraviolet region to thereby emit rays in the visible ray region and hence to allow a user to know time even in a dark place.

### Problems to be Solved by the Invention

In such wristwatch, the ultraviolet ray-emitting element emits invisible rays of light in the ultraviolet ray region, which then illumines the indicator including the hands and/or face thereof. Thus, only the luminous layers provided on the indicator members react to rays of light in the ultraviolet ray region to thereby emit rays of light in the visible ray region. Therefore, although a user can know time, the whole indicator cannot be illumined brightly, or is dark, undesirably.

It is a subject of the present invention to illumine the whole indicator brightly even when only a light emitting element that emits invisible rays of light in the ultraviolet ray region is used.

### Means for Solving the Problems

The present invention provides an illumining device comprising a case having at least one side open, a light emitting element disposed within the case for emitting rays of light in an ultraviolet ray region through the at least open side of the case, optically transparent sealing resin with which the case is filled so as to cover the light emitting element, and a luminous material mixed into the sealing resin for reacting to the rays of light in the ultraviolet ray region to thereby emit rays of light in a visible ray region.

According to the present invention, when the light emitting element emits rays of light in the ultraviolet ray region, these rays of light pass through the optically transparent sealing resin in the illumination case and then exit from the illumination case. Also, they illumine the luminous material mixed in the sealing resin. Then, the luminous material reacts to the rays of light in the ultraviolet region to thereby emit monochromatic rays of light of a specified wavelength in the visible ray region. Therefore, both the rays of light in the ultraviolet ray region emitted by the light emitting element and the rays of light in the visible ray region emitted by the luminous material exit from the case and then illumine the display. Thus, even when only the light-emitting element that emits invisible rays of light in the ultraviolet ray region is used, the whole indicator is brightened up compared to the prior art ones.

### BRIEF DESCRIPTION OF THE DRAWINGS

FIG. 1 is a front view of an essential portion of a first embodiment of the present invention applied to a wristwatch with a sweep-second hand;

FIG. 2 is an enlarged cross-sectional view of the essential portion taken along a line II-II of FIG. 1;

FIG. 3 is an enlarged cross-sectional 1 view of an illumining device of FIG. 2;

FIG. 4 is an enlarged cross-sectional view of an essential portion of a second embodiment of the invention applied to the wristwatch with a sweep-second hand;

FIG. 5 is an enlarged cross-sectional view of an illumining device of FIG. 4;

FIG. 6 is an enlarged plan view of a third embodiment of the invention applied to the wristwatch with a sweep-second hand;

FIG. 7 is an enlarged cross-sectional view of an essential portion of a fourth embodiment of the invention applied to a digital wristwatch;

FIG. 8 is a perspective view of a fifth embodiment of the invention applied to a cellular phone; and

FIG. 9 is an enlarged cross-sectional view taken along a line IX-IX of FIG. 8.

### BEST MODE FOR CARRYING OUT THE INVENTION

### First Embodiment

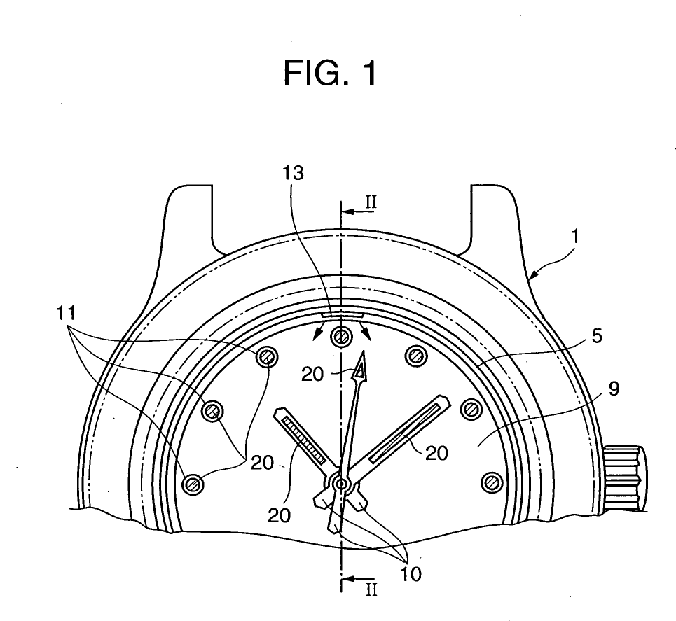

Referring to FIGS. 1-3, a first embodiment of the invention applied to the wristwatch with a sweep-second hand will be described.

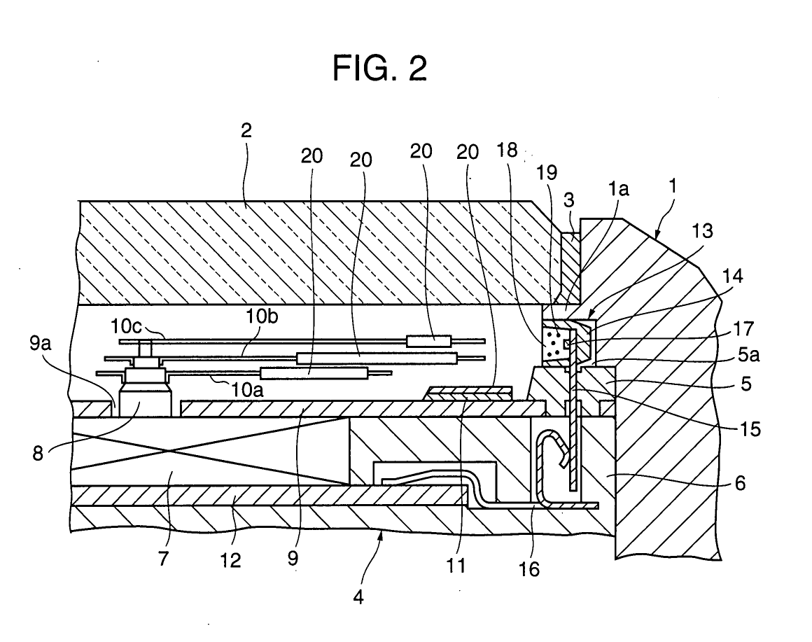

FIG. 1 is a front view of an essential portion of the inventive wristwatch. FIG. 2 is an enlarged cross-sectional view of the essential portion taken along a line II-II of FIG. 1;

This wristwatch has a case 1. A transparent crystal cover 2 is attached through packing 3 on a top of the case 1. A watch module 4 is received within the case 1 through a spacer 5. The case 1 has a back cover (not shown) through a waterproof ring (not shown).

The watch module 4 has at least an analog one of the analog and digital functions. As shown in FIG. 2, an analog movement 7 is provided within a housing 6, and has a hand shaft 8 that extends through a hole 9a in a face 9 provided on an upper surface of the housing 6. Hour, minute and second hands 10a, 10b and 10c are attached to an upper end of the hand shaft 8 so as to sweep above the face 9. Hour numerals 11 are formed at 1-12 o'clock along the periphery of the face 9. The face 9 and the hands 10a, 10b, 10c compose the indicator. A circuit board 12 on which an electronic circuit that drives the analog movement 7 is provided within the housing 6.

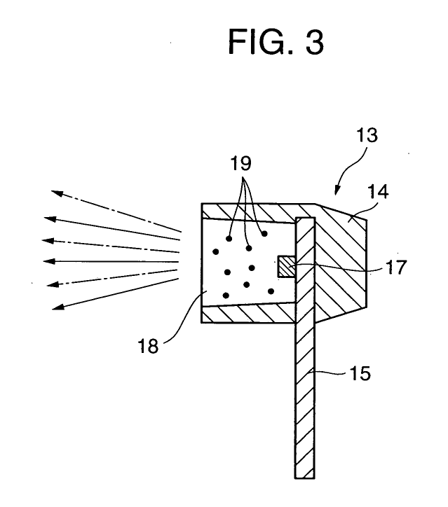

The spacer 5 is provided as a frame surrounding the periphery of the face 9 below a collar la formed on the inner periphery of the case 1. As shown in FIG. 2, an illumining device 13 is provided in a concavity 5a between the collar la and the spacer 5, for example, at 12 o'clock of the wristwatch so as to allow rays of light to be emitted inward of the case 1. As shown in FIGS. 2 and 3, the illumining device 13 has an illumination case 14 taking the form of a hollow cylinder open to the inside of the case 1. As shown in FIG. 2, an illumination board 15 extends from the illumination case 14 through the spacer 5 downward into the watch module 4 with an lower end of the board being electrically connected to the circuit board 12 in the watch module 4 through a connection member 16.

As shown in FIG. 3, a light-emitting element 17 called blacklight is attached to the illumining board 15 in the illumination case 14. The light emitting element 17 comprises an ultraviolet ray emitting diode (LED) or an ultraviolet lamp that emits invisible rays of light in the ultraviolet ray region whose wavelength is in a range of 365-385 manometers. As shown in FIG. 3, light-transparent sealing resin 18 including a mixture of transparent or translucent plastic and a luminous material 19 with which the illumination case 14 is filled so as to cover the light emitting element 17. The luminous material 19 reacts to rays of light in the ultraviolet ray region to thereby emit monochromatic rays of light of a specified wavelength in the visible ray region. The materials that emit monochromatic rays of light of a specified wavelength include materials that react to rays of light in the ultraviolet ray region to thereby emit red, blue and green (or yellow) rays of light, respectively. In this particular embodiment, the material that emits red light is used.

The hour numerals 11 on the face 9 and the hour, minute and second hands 10a, 10b, 10c are printed or coated with respective luminous layers, which react to rays of light in the ultraviolet ray region of a wavelength in a range of 350-420 manometers to thereby emit corresponding colored rays of light in the visible ray region. When the luminous layers 20 are not illumined with rays of light in the ultraviolet ray region, they are transparent. The luminous layers 20 can emit 10-13 different-colored rays of light including basically three different-colored; red, blue and green (or yellow) rays of light. In this case, the respective luminous layers 20 on the face 9 and hands 10a, 10b, 10c may emit rays of light of the same color, but preferably emit rays of light of different colors (wavelengths) in order to allow time to be viewed easily. For example, it is preferably arranged that the respective layers 20 on hour numerals 11 on the face 9 and the minute hand 10b emit green (or yellow) rays of light; the luminous layer 20 on the hour hand 10a emits blue rays of light; and the luminous layer 20 on the second hand 10c emits red rays of light.

According to such wristwatch, the respective hour numerals 11 on the face 9 and the respective luminous layers 20 on the hour, minute and second hands 10a, 10b and 10c are transparent in a bright place, for example, room where there are no rays of light in the ultraviolet ray region. Thus, the visibility of the respective hour numerals 11 on the face 11 and the hour, minute and second hands 10a, 10b and 10c is not influenced by the respective luminous layers 20, and the face 9 and the respective hands 10a, 10b, 10c are visible through the crystal cover 2 from the outside of the case 1. Therefore, as in the general wristwatch, the user can recognize time.

When the light emitting element 17 of the illumining device 13 is driven, in a dark place, for example, room where rays of light in the ultraviolet ray region are not virtually present, it emits rays of light in the ultraviolet ray region, which directly pass through the sealed resin 18 and then exits from the illumination case 14 as well as illumines the luminous materials 19 mixed in the sealed resin 18. Then, the luminous layers 19 react to the rays of light in the ultraviolet ray region to thereby emit monochromatic light of a specified wavelength, for example red light, in the visible ray region. Thus, both the rays of light in the ultraviolet ray region emitted from the light emitting element 17 and the monochromatic rays of a specified wavelength in the visible ray region emitted from the luminous layers 19 are emitted out of the illumination case 14 to thereby illumine the face 9 and the hands 10a, 10b, 10c of the indicator.

At this time, the luminous layers 20 provided on the respective hour numerals 11 and hands 10a, 10b, 10c of the face 9 react to the rays of light in the ultraviolet ray region to thereby emit respective rays of light in the visible ray region. For example, the respective luminous layers 20 on the hour numerals 11 and the minute hand 10a of the face 9 emit green (or yellow) light. The luminous layer 20 on the hour hand 10b emits green light. The luminous layer 20 on the second hand 10c emits red light. Therefore, even when only the light emitting element 17 that emits invisible rays of light in the ultraviolet ray region is used as such, the whole indicator area including the face 9 and the hands 10a, 10b, 10c is brightly illumined with the monochromatic light of a specified wavelength, or red light, in the visible ray region and the rays of light in the visible ray region emitted by the respective luminous layers 20 provided on the hour numerals 11 and hands 10a, 10b, 10c on the face 9.

Thus, the face 9 and hands 10a, 10b, 10c can be recognized through the crystal cover 2 from the outside of the case 1. Therefore, time can be recognized even in a dark place. At this time, as described above, the luminous layers 20 provided on the hour numerals 11 and hands 10a, 10b, 10c of the face 9 react to rays of light in the ultraviolet ray region emitted from the illumining device 13 to thereby emit rays of light of different wavelengths in the visible ray region. Therefore, plentiful colors that can be used in this wristwatch are provided by rays of light in the visible ray region emitted by the respective luminous layers 20. Thus, wristwatches of high colorfulness and high fanciness are provided.

### Second Embodiment

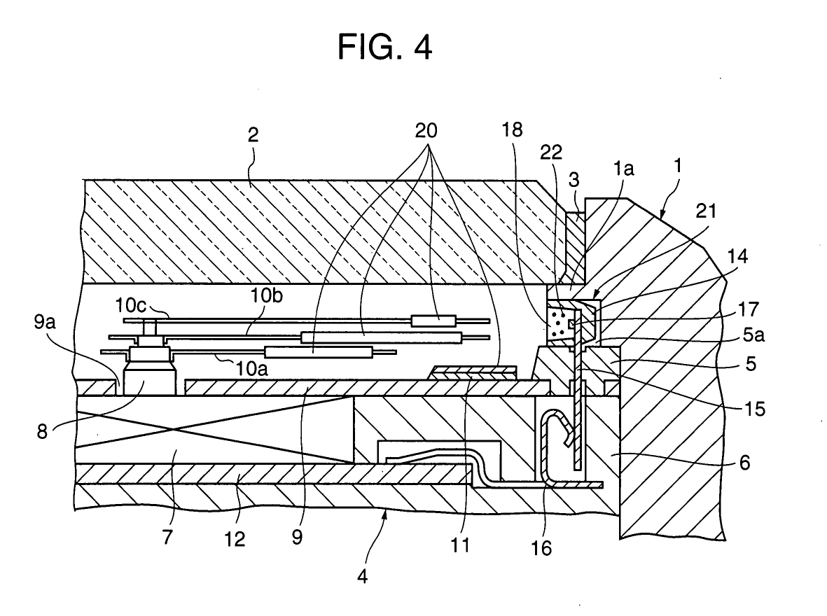

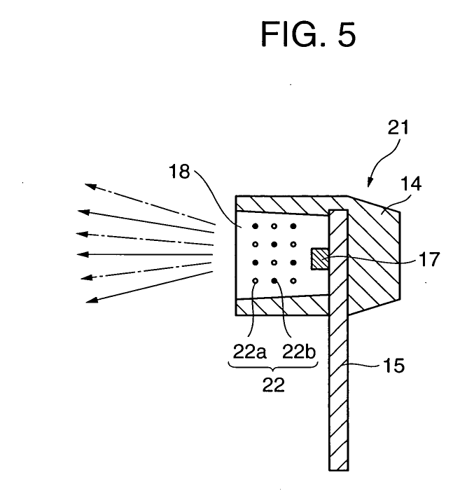

Referring to FIGS. 4 and 5, a second embodiment of the invention applied to the wristwatch with a sweep-second hand will be described. The same reference numeral is used to denote the same element of the second and first embodiments of FIGS. 4, 5 and FIGS. 1-3.

The wristwatch of this embodiment has substantially the same structure as the first embodiment excluding that it has a structure in which the illumining device 21 emits rays of light in the ultraviolet ray region as well as rays of light of different wavelengths in the visible ray region. The illumining device 21 has filled its case 14 with sealing resin 18 that covers a light emitting element 17 provided within the illumination case 14. Luminous materials 22 are mixed in the sealing region 18 and react to the rays of light in the ultraviolet ray region to thereby emit rays of light of different wavelengths in the visible ray region.

In this case, the luminous materials 22 contain in combination at least two of the materials that react to the rays of light in the ultraviolet ray region to thereby emit red, blue and green (or yellow) rays of light, respectively. For example, in the second embodiment the luminous materials 22 contain materials 22a and 22b that react to the rays of light in the ultraviolet ray region to thereby emit red and blue rays of light, respectively, which are then mixed and exit from the illumining case 14.

Briefly, such wristwatch with a sweep-second hand produces advantageous effects similar to those produced by the first embodiment. Especially, the respective materials 22a and 22b of the luminous material 22 react to the rays of light in the ultraviolet ray region emitted by the light emitting element 17 of the illumining device 21 to thereby emit rays of light of different wavelengths, for example, red and blue rays of light, respectively, of the visible ray region. These rays of light of different wavelengths are then mixed to become substantially white light, and hence bright light. Thus, bright light visible to the man's eyes can illumine the face 9 and hands 10a, 10b, 10c of the indicator along with rays of light in the ultraviolet ray region. Thus, the wristwatch of the second embodiment can illumine the whole indicator area more lightly than that of the first embodiment to thereby allow the user to recognize time more clearly.

### Third Embodiment

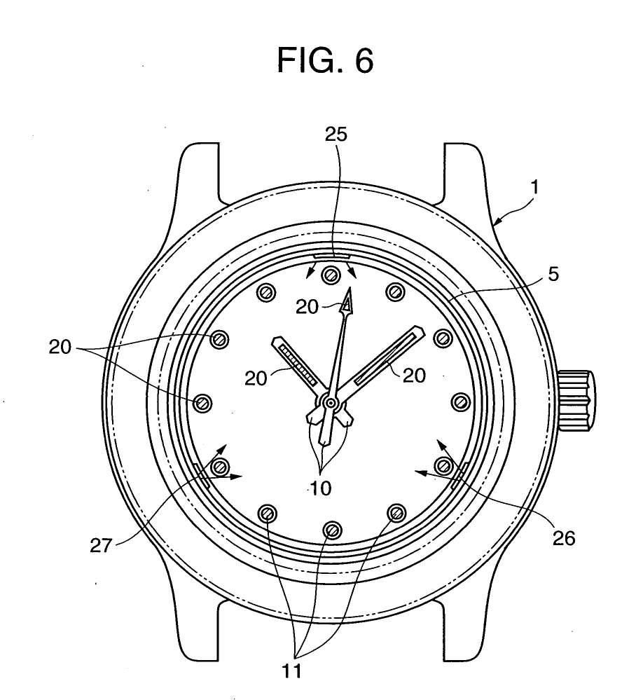

Referring to FIG. 6, a third embodiment of the invention applied to the wristwatch with a sweep-second hand will be described. Also, the same reference numeral is used to denote the same element of the third and first embodiments of FIG. 6 and FIGS. 1-3.

This wristwatch has substantially the same structure as the first embodiment excluding that a plurality of illumining devices 25-27 is provided at desired positions on a spacer 5 within the case 1.

More specifically, the illumining devices 25-27 are housed in concavities 5a at 12, 4 and 8 o'clock in the spacer 5. In each of the illumining devices 25-27, a light emitting element 17 is provided in an illumination case 14 through an illumination board 15. Light emitting materials 19 that emit rays of light of different wavelengths in the visible ray region are mixed in sealing resin 18 with which the case 14 is filled so as to cover the light emitting element 17. Thus, the illumining device emits rays of light in the ultraviolet ray region and different-colored rays of light out of the illumination case 14.

For example, the illumining device 25 at 12 o'clock is constructed so that the luminous material 19 reacts to the rays of light in the ultraviolet ray region to thereby emit red rays of light; the illumining device 26 at 4 o'clock is constructed so that the luminous material 19 reacts to the rays of light in the ultraviolet ray region to thereby emit blue rays of light; and the illumining device 27 at 8 o'clock is constructed so that the luminous material 19 reacts to the rays of light in the ultraviolet ray region to thereby emit green (or yellow) rays of light. In this wristwatch, the respective illumining devices 25-27 are arranged to be lighted sequentially.

Such wristwatch produces advantageous effects similar to those produced by the first embodiment. In addition, especially, by causing the respective illumining devices 25-27 to emit rays of light sequentially, the face 9 and the hands 10a, 10b, 10c of the indicator can be sequentially illumined with rays of light of different colors or wavelengths in the visible ray region. Thus, since the respective illumining devices 25-27 emit different-colored rays of light, plentiful color variations are provided due to light illumination. The number of colored rays of light in this embodiment is larger than that in the first embodiment. Therefore, wristwatches with a sweep-second hand that has higher colorfulness, higher fanciness and higher commercial value are provided.

While in the third embodiment the respective illumining devices 25-27 were illustrated as sequentially lighted, the illumining devices may be lighted simultaneously. In this case, the rays of light of different wavelengths in the visible ray region emitted by the respective illumining devices 25-27 are mixed to become bright substantially white light. Thus, the face 9 and the hands 10a, 10b, 10c of the indicator are illumined more brightly to thereby allow the user to view them more clearly.

### Fourth Embodiment

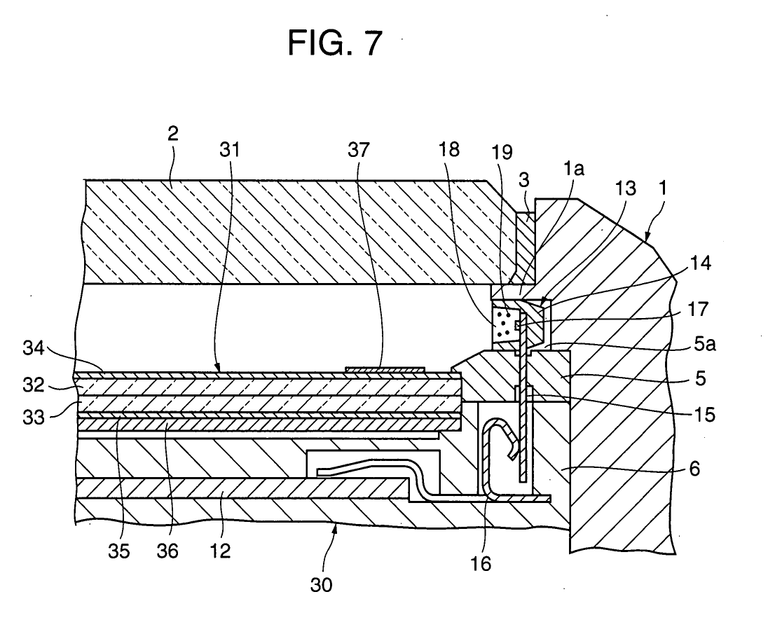

Referring to FIG. 7, a fourth embodiment of the invention applied to a digital type wristwatch will be described. The same reference numeral is used to denote the same element of the fourth and first embodiment of FIG. 7 and FIGS. 1-3.

The digital wristwatch has substantially the same structure as the first embodiment excluding that a watch module 30 housed through a spacer 5 within the case 1 has a digital function. More specifically, the watch module 30 includes a liquid crystal display 31 on the housing 6 instead of the indicator including the face 9 and the hands 10a, 10b, 10c.

As shown in FIG. 7, the liquid crystal display 31 has a pair of transparent electrodes (upper and lower) 32 and 33 between which liquid crystal (not shown) is filled, polarizing plates 34 and 35 that are provided on an upper surface of the upper electrode 32 and a lower surface of the lower electrode 33, respectively, with an reflector 34 provided on a lower surface of the lower polarizing plate 35. By selectively applying a voltage across the pair of electrodes 32 and 33, information such as time is displayed electro-optically. Luminous layers 37 that express marks, figures and/or symbols are provided on an upper surface of the liquid crystal display 31, or the upper polarizing plate 35 excluding in the display area of the liquid crystal display 31.

Like the luminous layers 20 of the first embodiment, the luminous layers 37 react to rays of light in the ultraviolet ray region to thereby emit rays of light in the visible ray region whereas when it is not illumined with rays of light in the ultraviolet ray region, it is transparent. It emits 10-13 different-colored rays of light including basically three different-colored, or red, blue and green (or yellow), rays of light. In this case, the luminous layers 37 may be all made of the same material so as to emit the same color, but in order to improve fanciness, they are preferably composed so as to emit rays of light of different colors or wavelengths.

Also, like the first embodiment this wristwatch has an illumining device 13 received in a concavity 5a provided at a predetermined position on a spacer 5. As in the first embodiment, the illumining device 13 comprises a light emitting element 17 within the illumination case 14 through an illumination board 15. The case 14 is filled with sealing resin 18 so as to cover the light-emitting element 17. The resin 18 contains a luminous material 19 that reacts to rays of light in the ultraviolet ray region to thereby emit rays of light in the visible ray region. Thus, the rays of light in the invisible ultraviolet ray region and in the visible ray region are emitted from the illumination case 14.

According to such wristwatch, the luminous layers 37 provided on the liquid crystal display 31 become transparent in a bright place or room in which rays of light in the ultraviolet ray region are not virtually present. Thus, the visibility of the liquid crystal display 31 is not influenced by the luminous layer 37 and information such as time displayed on the display 31 can be viewed from the outside of the case 1 through the watch crystal cover 2. That is, external light incident to the case 1 through the crystal cover 2 passes through the transparent luminous layers 37, the upper polarizing plate 34, the upper and lower electrodes 32, 33 and the lower polarizing plate 35 of the liquid crystal display 31 and is then reflected by the reflector 36. The reflected rays of light pass through the crystal cover 2 in a path reverse to that mentioned so far and then emitted through the crystal cover 2 to the outside. Thus, the information displayed on the display 31 can be viewed from the outside of the case 1.

When the light emitting element 17 of the illumining device 13 is driven in a dark place or room where no rays of light in the ultraviolet ray region are virtually present, it emits rays of light in the ultraviolet ray region as in the first embodiment. The rays of light in the ultraviolet ray region then pass through the optically transparent sealing resin 18 in the illumination case 14, exits from the illumination case 14 and illumines the luminous material 19 mixed in the sealing resin 18. Then, the luminous material 19 reacts to the rays of light in the ultraviolet region to thereby emit monochromatic rays of light of a specified wavelength in the visible ray region. Therefore, both the rays of light in the ultraviolet ray region emitted by the light emitting element 17 and the rays of light in the visible ray region emitted by the luminous material 19 illumine the display 31.

At this time, since the display 31 is illumined with the rays of light in the visible ray region, the information displayed on the display 31 can be viewed, as in the above case. In addition, since the luminous layers 37 provided on the display 31 react to the rays of light in the ultraviolet ray region to thereby emit the rays of light in the visible ray region. Thus, the luminous layer 37 can also be viewed. Therefore, as in the first embodiment even when only the light emitting element 17 that emits rays of light in the ultraviolet ray region invisible to the man's eyes is used as such, both the rays of light in the visible ray region emitted from the illumining device 13 and the rays of light in the visible ray region emitted by the luminous layers 37 on the display 31 serve to illumine the whole display 31 brightly. This allows the user to view information displayed on the display 31 clearly even in a dark place. The luminous layers 37 emit colorful rays of light to thereby provide time indication of high colorfulness and high fanciness.

### Fifth Embodiment

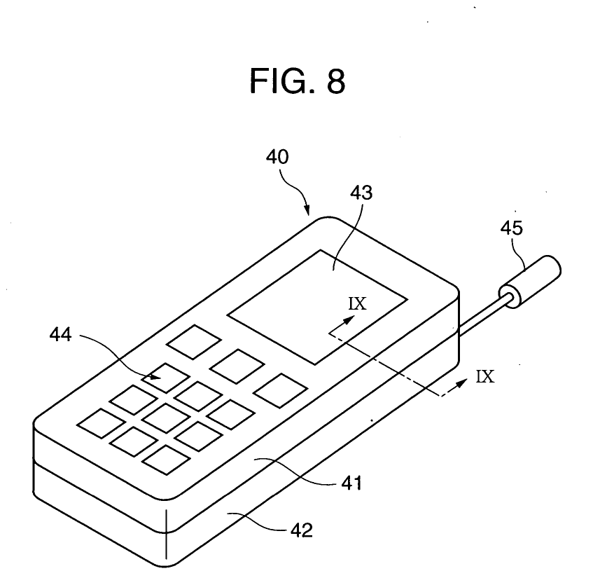

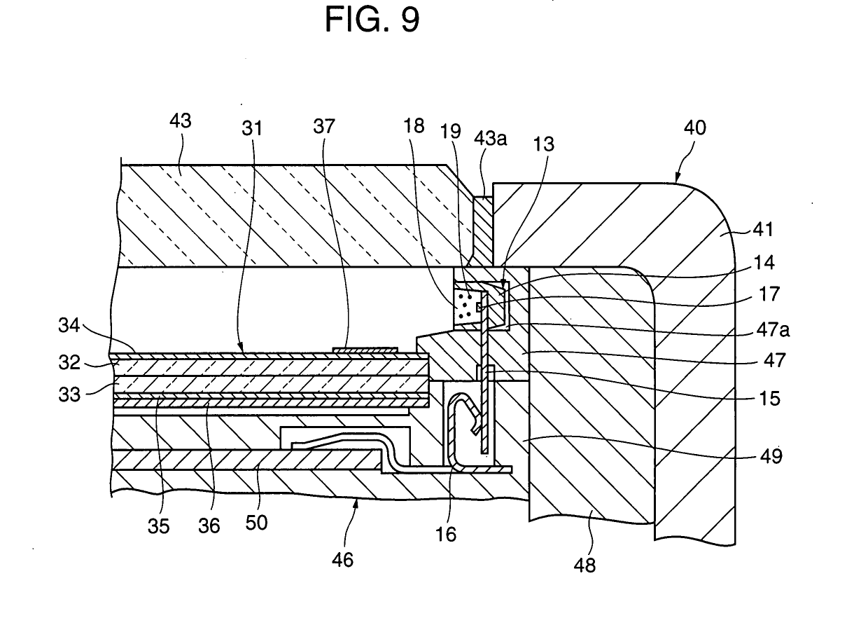

Referring to FIGS. 8 and 9, a fifth embodiment of the invention applied to a cellular phone will be described. The same reference numeral is used to denote the same element of the fifth and fourth embodiments of FIGS. 8, 9 and FIG. 7.

As shown in FIG. 8, the cellular phone comprises a plastic case 40 composed of upper and lower case halves 41 and 42. The upper case half 41 has a transparent protective glass window 43 provided through packing 43a on an upper surface of an upper portion thereof. Various key buttons 44 necessary for fulfilling the phone function are provided on an upper surface of a lower portion of the upper case half 41. An antenna 45 is provided extendable at an end of the upper portion of the case 40.

As shown in FIG. 9, a phone module 46 is provided through a spacer 47 in an inner frame 48 within the case 40. The phone module 46 comprises various elements necessary for fulfilling the phone function. A liquid crystal display 31 is provided below the glass window 43 within the housing 49. In addition, a circuit board 50 on which an electronic circuit necessary for fulfilling the phone function is provided is housed within the housing 49. The spacer 47 is provided below the periphery of the window 45 between the upper periphery of the module 46 and the upper case half 41. Like the fourth embodiment, an illumining device 13 is provided in a cavity 47a provided at a predetermined position on the spacer 47.

Like the first embodiment, a light emitting element 17 is provided in the illumining device 13 on an illumination board 15 within the illumination case 14, which is filled with sealing resin 18 so as to cover the light emitting element 17. The sealing resin 18 contains a luminous material 19 that reacts to rays of light in the ultraviolet ray region to thereby emit rays of light in the visible ray region. Thus, both rays of light in the ultraviolet ray region and the visible ray region are emitted. Like the fourth embodiment, luminous layers 37 that express marks, figures and/or symbols are provided on the upper surface of the display 31 of the module 46 excluding in the indicator area of the display 31. Also, like the fourth embodiment the luminous layers 37 react to the rays of light in the ultraviolet ray region to thereby emit rays of light in the visible ray region. When the luminous layers 37 are not illumined with the rays of light in the ultraviolet ray region, they are transparent. The luminous layers may be arranged so as to emit rays of light of the same color. Preferably, they emit rays of light of different colors (or different wavelengths) depending upon the positions thereon in order to improve fanciness.

According to such cellular phone, the luminous layers 37 provided on the liquid crystal display 31 are transparent in a bright place or room in which rays of light in the ultraviolet ray region are not virtually present. Thus, the visibility of the liquid crystal display 31 is not influenced by the luminous layers 37 and information such as time displayed on the display 31 can be viewed from the outside of the case 1 through the protective crystal window 43. That is, external light incident to the case 40 through the protective crystal window 43 passes through the transparent luminous layers 37, the upper polarizing plate 34, the upper and lower electrodes 32, 33 and the lower polarizing plate 35 of the liquid crystal display 31, and is then reflected by the reflector 36. The reflected rays of light pass through the protective crystal window 43 in a path reverse to that mentioned so far and then emitted through the protective crystal window 43 to the outside. Thus, the information displayed on the display 31 can be viewed from the outside of the case 40.

When the light emitting element 17 of the illumining device 13 is driven, it emits rays of light in the ultraviolet ray region as in the first embodiment in a dark place or room where no rays of light in the ultraviolet ray region are virtually present. The rays of light in the ultraviolet ray region then pass through the optically transparent sealing resin 18 in the illumination case 14 and exits from the illumination case 14. Also, it illumines the luminous material 19 mixed in the sealing resin 18. Then, the luminous material 19 reacts to the rays of light in the ultraviolet region to thereby emit monochromatic rays of light of a specified wavelength in the visible ray region. Therefore, both the rays of light in the ultraviolet ray region emitted by the light emitting element 17 and the rays of light in the visible ray region emitted by the luminous material 19 illumine the display 31.

At this time, since the display 31 is illumined with the rays of light in the visible ray region, the information displayed on the display 31 can be viewed, as in the above case. In addition, since the luminous layers 37 provided in the display 31 react to the rays of light in the ultraviolet ray region to thereby emit the rays of light in the visible ray region. Thus, the luminous layer 37 can also be viewed. Therefore, as in the first embodiment, even when only the light emitting element 17 that emits rays of light in the ultraviolet ray region invisible to the man's eyes is used as such, both the rays of light in the visible ray region emitted from the illumining device 13 and the rays of light in the visible ray region emitted by the luminous layers 37 on the display 31 serve to illumine the whole display 31 brightly. This allows the user to view information displayed on the display 31 clearly even in a dark place. The luminous layers 37 produces plentiful colors due to light illumination to thereby provide display of high colorfulness and high fanciness.

While in the fourth and fifth embodiments the luminous layers 37 were illustrated as provided on the upper surface of the display 31, the luminous layers 37 may be provided on the reflector instead or may be provided both on the upper surfaces of the display 31 and the reflector 36. In this case, if a luminous layer 37 is provided on the whole upper surface of the reflector 36, it reacts to the rays of light in the ultraviolet ray region from the illumining device 13 to thereby emit rays of light in the visible ray region, which can be used as backlight.

While in the fourth and fifth embodiments the reflector-type displays 31 having the reflector 36 were illustrated as provided, a transparent type display with a backlight device may be used instead. Alternatively, a translucent reflection-type display with a backlight device and a half mirror may be used.

While in the fourth and fifth embodiments the luminous layers 19 of the illumining device 13 were illustrated as reacting to the rays of light in the ultraviolet ray region to thereby emit monochromatic rays of light of a specified wavelength in the visible ray region, the present invention is not limited to this particular case. For example, like the second embodiment, the luminous material 22 may include at least two of the materials that react to rays of light in the ultraviolet ray region to thereby emit red, blue and green (or yellow) rays of light. In this arrangement, bright substantially white light is obtained to thereby illumine the whole display 31 more brightly, as in the second embodiment.

While in the fourth and fifth embodiments the single illumining device 13 was illustrated as provided on the spacer 5 or 47, a plurality of illumining devices 20-27 may be provided at desired positions on the spacer 5 or 47, for example as in the third embodiment, so as to emit rays of light of different wavelengths in the visible ray region and rays of light in the ultraviolet ray region. In this arrangement, when the illumining devices 25-27 are caused to sequentially emit rays of light of different wavelengths in the visible ray region to thereby illumine the display 31 accordingly. Therefore, plentiful colors are produced by the respective rays of light to thereby bring about indication or display of high colorfulness and high fanciness. When the plurality of illumining device 25-27 are caused to emit rays of light of different wavelengths simultaneously in the visible rays region, these rays of light are mixed to become bright substantially white light to thereby illumine the whole display 31 more brightly.

While in the first-fifth embodiments and their modifications the wristwatches and the cellular phones were illustrated, the invention is applicable widely to electronic devices such as electronic notebooks, electronic dictionaries, portable terminals, personal computers, and printers, various devices such as car meters, and their parts.

As will be obvious from the above, in these embodiment as shown in FIGS. 1-9, the illumining device comprises a case (14) having at least one side open, a light emitting element (17) disposed within the case for emitting rays of light in an ultraviolet ray region through the at least open side of the case, optically transparent sealing resin (18) with which the case is filled so as to cover the light emitting element, and a luminous material (19, 22) mixed into the sealing resin for reacting to the rays of light in the ultraviolet ray region to thereby emit rays of light in a visible ray region.

According to this embodiment, when the light emitting element emits rays of light in the ultraviolet ray region, these rays of light pass through the optically transparent sealing resin in the illumination case and then exit from the illumination case. Also, they illumine the luminous material mixed in the sealing resin. Then, the luminous material reacts to the rays of light in the ultraviolet region to thereby emit monochromatic rays of light of a specified wavelength in the visible ray region. Therefore, both the rays of light in the ultraviolet ray region emitted by the light emitting element and the rays of light in the visible ray region emitted by the luminous material exit from the case and then illumine the display. Thus, even when only the light emitting element that emits invisible rays of light in the ultraviolet ray region is used, the whole indicator is brightened up much more than the prior art ones.

In the embodiment, as shown in FIGS. 1-3, the luminous material (19) of the illumining device (13) comprises a material that reacts to the rays of light in the ultraviolet ray region to thereby emit rays of light of a specified wavelength in the visible ray region.

According to this embodiment, the luminous material emits monochromatic rays of light of a specified wavelength; for example, red, blue and green (or yellow) rays of light, in the visible ray region. Thus, the monochromatic rays of light emitted from the illumination case produce a coloring effect and an ornamenting effect.

Also, in one embodiment the luminous material (22) of the illumining device (21) comprises a plurality of materials (22a, 22b) that react to the rays of light in the ultraviolet ray region to thereby emit rays of light of different wavelengths in the visible ray region, as shown in FIGS. 4 and 5.

According to this embodiment the respective luminous materials react to the rays of light in the ultraviolet ray region emitted by the light emitting element to thereby emit visible rays of light of different wavelengths, which are then mixed to become bright substantially white rays of light. These rays of light are then emitted along with the rays of light in the ultraviolet ray region to thereby illumine the indicator brightly.

In the embodiments, as shown in FIGS. 1-9, the electronic apparatus comprises an apparatus case (wristwatch case 1, apparatus case 40) that has housed the illumining device (13, 21, 25-27), the apparatus case having a window (watch crystal cover 2, protective crystal window 43) thereon; an indicator (face 9, hands 10a, 10b and 10c; liquid crystal display 31) disposed within the apparatus case so as to face the window and adapted to be illumined with rays of light emitted by the illumining device; and a luminous layer (20, 37) provided on the indicator for reacting to the rays of light in the ultraviolet region to thereby emit rays of light in the visible ray region.

According to this embodiment, both the rays of light in the ultraviolet rays region emitted by the light-emitting element of the illumining device of the illumining device and the rays of light in the visible ray region emitted by its luminous materials of the illumining device illumine the whole indicator. In addition, the luminous layers on the indicator react to the emitted rays of light in the ultraviolet ray region to thereby emit rays of light in the visible ray region, which illumine the whole indicator. Thus, the whole indicator is illumined much more brightly.

In the embodiments, as shown in FIGS. 1-6, the electronic apparatus comprises a plurality of luminous layers (20) provided at desired positions on the indicator (face 9 and hands 10a, 10b and 10c) for reacting to rays of light in the ultraviolet ray region to thereby emit rays of light of different wavelengths in the visible ray region.

According to these embodiments the whole indicator is illumined brightly. In addition, since the light emitting elements provided at different positions on the indicator react to rays of light in the ultraviolet ray region to thereby emit rays of light of different wavelengths in the visible ray region. Thus, plentiful color variations due to light illumination and hence time indication of high colorfulness and high fanciness are obtained.

In the embodiment, as shown in FIG. 6, the electronic apparatus comprises a plurality of such illumining devices (25-27) disposed at desired positions within the apparatus case for emitting rays of light of different wavelength in the visible ray region and rays of light in the ultraviolet ray region.

According to this embodiment, the illumining devices disposed at different positions within the case emit the rays of light in the ultraviolet ray region and rays of light of different wavelengths in the visible ray region. Thus, when the respective illumining devices are driven sequentially, they sequentially illumine the indicator with the rays of light of different wavelengths in the visible ray region. Therefore, various colored rays of light are produced and the indicator provides indication and/or display of high colorfulness and high fanciness. In addition, when the respective illumining devices are driven simultaneously, the rays of light of different wavelengths in the visible ray region emitted by the respective illumining devices are mixed to become bright substantially white light and hence the whole indicator is illumined more brightly.

This application is based on Japanese Patent Application No. 2002-296076 filed on Oct. 9, 2002, and including specification, claims, drawings and summary. The disclosure of the above Japanese patent application is incorporated herein by reference in its entirety.

1. An illumining device (13,21,25,26,27) comprising:
a case (14) having at least one side open;
a light emitting element (17) disposed within the case for emitting rays of light in an ultraviolet ray region through the at least open side of the case;
optically transparent sealing (18) resin with which the case is filled so as to cover the light emitting element; and
a luminous material (19,22) mixed into the sealing resin for reacting to the rays of light in the ultraviolet ray region to thereby emit rays of light in a visible ray region.

2. The illumining device according to claim 1, wherein the luminous material (19) comprises a material that reacts to the rays of light in the ultraviolet ray region to thereby emit rays of light of a specified wavelength in the visible ray region.

3. The illumining device according to claim 1, wherein the luminous material (22) comprises a plurality of materials that react to the rays of light in the ultraviolet ray region to thereby emit rays of light of different wavelengths in the visible ray region.

4. An electronic apparatus (13,21,25,26,27) comprising:
an apparatus case (1,40) that has housed the illumining device according to claim 1, the apparatus case having a window (2,43) thereon;
an indicator (9;10a,10b,10c;31) disposed within the apparatus case so as to face the window and adapted to be illumined with rays of light emitted by the illumining device; and
a luminous layer (20,37) provided on the indicator for reacting to the rays of light in the ultraviolet region to thereby emit rays of light in the visible ray region.

5. The electronic apparatus according to claim 4, comprising a plurality of luminous layers (9;10a,10b,10c) provided at desired positions on the indicator for reacting to rays of light in the ultraviolet ray region to thereby emit rays of light of different wavelengths in the visible ray region.

6. The electronic apparatus according to claim 4, comprising a plurality of such illumining devices (9;10a,10b,10c) disposed at desired positions within the apparatus case (1) for emitting rays of light of different wavelength in the visible ray region and rays of light in the ultraviolet ray region.
